(19) United States
(12) Patent Application Publication
(10) Pub. No.: US 2006/0226060 A1
(43) Pub. Date: Oct. 12, 2006

(54) Water treatment turbine apparatus and method

(76) Inventor: Richard D. Mercer, Spring, TX (US)

Correspondence Address: KENNETH L. NASH, P.O. BOX 680106, HOUSTON, TX, 77268-0106, US

(21) Appl. No.: 11/148,070

(22) Filed: Jun. 8, 2005

Related U.S. Application Data
(60) Provisional application No. 60/670,145, filed on Apr. 11, 2005.

(51) Int. Cl. C02F 1/48

(52) U.S. Cl. 210/222; 210/243; 204/193; 204/557

(57) ABSTRACT

The present invention provides an improved water purifier and method. In one possible embodiment, the present invention provides a turbine mounted in or to piping of a pool or spa filtering system. The turbine comprises one or more rotatable elements such as fins, paddles, blades, propellers, or the like which are responsive to water flow through the piping to produce rotation. The rotatable element may comprise magnets which rotate along with the rotatable element to produce a rotating magnetic field. The rotating magnetic field may be utilized for generating electricity utilizing various types of electric power generators. Electricity so produced may be utilized to power a water purification unit such as a chlorine generator, UV generator, or an ozone generator. In one embodiment, the output of the water purification unit is directed into turbulence, such as turbulence produced by the rotatable element, so that the purification efficiency is enhanced.

This application claims benefit of U.S. Provisional Application No. 60/670,145 filed Apr. 11, 2005, which is incorporated herein in its entirety.

### TECHNICAL FIELD

The present invention relates generally to water purification and, in one particular preferred embodiment, to an in-line power generator for use in water purification and other water related purposes.

### BACKGROUND ART

Chlorine is the most widely used method of neutralizing disease causing pathogens and bacteria in a body of water. Although there are other means of neutralizing bacteria and pathogens, chlorine is the disinfectant of choice for many reasons. Chlorine kills pathogenic organisms efficiently and effectively by attacking the cell or the cell enzyme system. In either case, the inactivation of the pathogenic organisms is achieved. The chlorine residual HOCL is a longer lasting residual that effectively kills pathogens until dissipated. EPA requirements for potable or public water facilities and state requirements for chlorine levels are as follows: 0.2 mg/L-0.5 mg/L free chlorine residual. However, even though chlorine is relatively inexpensive as compared to other “Water Treatment Turbine Apparatus and Method” Inventor: Richard D. Mercer types of sanitizers, the cost of chlorine, for instance to sanitize a pool, becomes an extremely expensive proposition over the lifetime of the pool. Moreover, significant hazards, time, labor, and other costs are associated with storing and handling toxic chlorine and/or other hazardous chemicals such as chlorine tablets, oxidizers, algaecides or algae inhibitors. Another problem with the use of chlorine is the need to stabilize the chlorine such that it remains in the water as UV rays tend to deplete or damage chlorine molecules during the day. Cyanuric acid is therefore frequently utilized as a stabilizer in chlorine tablets and is present in dichlor. Cyanuric acid can build up to undesirable levels and should be monitored by knowledgeable pool operators using special test kits. High content of cyanuric acid in pool water presents a health problem, damages pool plaster, and may lock the free chlorine molecule. High levels of cyanuric acid requires draining the body of water and adding fresh water to reduce concentrations.

Other methods of disinfection include use of chlorine dioxide, which is unstable and may produce undesirable byproducts such as chlorates. Chlorine dioxide residuals do not last as long as chlorine residuals and is more difficult to measure and monitor. Ozone, which is an unstable chemical, breaks down rapidly as does UV (ultra violet light) and leaves no residual disinfectant in the water supply. In the past, Ozone and UV have been considered costly alternatives because the electricity and equipment required to produce ozone gas and UV is expensive compared to other disinfectants as chlorine. Other chemical oxidizers include potassium permanganate, which is more expensive than chlorine and produces a pink or brown residue in the water. Iodine, which is expensive, stains and produces an objectionable taste. Bromine chloride and hydrogen peroxide are both relatively more expensive methods of sanitizing the water.

Silver, being the least effective method of sanitizing is expensive and reaches a maximum contaminate level (MCL) of 0.5 mg/L which restricts its usefulness as an effective sanitizer but does serve the purpose, even in small quantities, as an algae growth inhibitor. Nonetheless, some prior art devices rely completely on the use of metallic ions or metallic oxides for water purification. The sole use of metallic ions or metallic oxides cannot neutralize disease causing pathogens without breaking or seriously exceeding E.P.A. primary standards for maximum contamination levels (MCL) of copper (Cu) 1 mg/L or 1.0 ppm and Silver (Ag) 0.5 mg/L or 0.05 ppm. Serious side effects to public health could occur should these perimeters be breached either in public, potable, bathing, or swimming water, as all may be ingested.

My previous U.S. Pat. No. 6,508,929, issued Jan. 21, 2003, discloses one possible solution to the above problems wherein one possible embodiment of that invention comprises a floating salt housing that produces chlorine utilizing solar power. The present invention provides yet another device operable to inexpensively produce chlorine over a long term.

Some systems may utilize 115 VAC or 240 VAC which is applied to a power supply which produces DC voltage to apply to cell plates or electrodes to produce chlorine due to the presence of a salt brine. The salt brine may comprise or consist of salt water or pool water which has at least some sufficient amount of salt, i.e., sodium chloride, dissolved therein for operation in producing chlorine and which if desired may also include a high concentration or even saturation of salt within the water. The power cables required in conventional systems adds significant additional cost for installation and may be problematic to install depending on where power is desired and may also create a hazard due to the presence of salt water, i.e., the saltwater brine which may consist of even small amounts of salt and as opposed to pure freshwater which is not a particularly good electric conductor. As well, the consumer has increased electricity bills to pay for chlorine generation. Moreover, electrical systems in close proximity with salt water can be dangerous in themselves and may tend to cause accidental electrical shock hazards under some conditions. The significant maintenance/repair/operation costs involved with such systems can be disappointing to pool owners who were led to believe their system would reduce costs by eliminating the need to purchase chlorine.

As disclosed in the below-listed patents, it is well known to utilize chlorine or ion producing generators to treat water. However, besides the problems already mentioned above, such devices tend to have significant reliability problems and/or require complex chemical production and containment requirements. Moreover, such systems may tend to require expensive installation costs and utilize significant amounts of power grid electricity.

U.S. Pat. No. 5,059,296, issued Oct. 22, 1991, and U.S. Pat. No. 5,085,753, issued Feb. 4, 1992, to M. Sherman, disclose a portable self-contained solar powered water purifier for swimming pools, spas, and other bodies of water is disclosed. The purifier includes a buoyant housing for supporting a solar cell array above the surface of water to be treated and a purification cell below the surface of water to be treated. Suitable electrical connections, between the solar cell array and purification cell, are sealed to prevent the entry of water therebetween which could result in electrical shorts and corrosion. The purification cell includes a sacrificial anode, having a metal alloy essentially composed of copper and silver and a cathode which is preferably constructed of stainless steel so as to not react adversely with the sacrificial anode. Metallic copper and silver ions are released by the sacrificial anode to prevent algae and bacterial growth. The anode and cathode are structurally interrelated and secured to each other and to the buoyant housing and the solar cell array to provide a practical, durable and long-lasting unit.

U.S. Pat. No. 4,337,136, issued Jun. 29, 1982, to V. M. F. Dahlgren, discloses a pair of electrodes formed of silver-copper alloy which depend from the bottom wall of a floating container. The latter is arranged to float on the surface of a body of water to be treated and contains a battery which is connected in circuit with the electrodes through a timer switch and a current reversing switch. Passage of a direct current across the electrodes ionizes the water and the silver and copper ions destroy and prevent the growth of bacteria and algae.

U.S. Pat. No. 4,097,356, issued Jun. 27, 1978, to D. Yates, discloses a chlorine generator for the production of chlorine and hydrogen, with the chlorine being used for the treatment of swimming pools, sewage treatment facilities and drinking water is provided. The generator is characterized by an ion-permeable perfluorosulfonic acid membrane separating an anode and cathode compartment. Chlorine generation is controlled by an electrical timer, a chlorine pressure sensor gauge and, in an alternative embodiment, a chlorine sensor. Chlorine and hydrogen are withdrawn from the generator through aspirators and thereafter introduced into the water to be treated

U.S. Pat. No. 4,250,126, issued Feb. 10, 1981, and U.S. Design Pat. No. 261,415, issued Oct. 21, 1981, to D. Yates, discloses a chlorine generator including an assembly for an electrolytic cell generating the chlorine and a separate assembly for feeding the chlorine gas into a body of water. The cell assembly preferably includes two separate electrolytic solutions separated by an ion permeable membrane, such that an anode and a cathode are positioned on each side of the membrane. The gas feed assembly is in fluid communication with the cell housing by two separate conduits which accommodate the flow of gas from the cell to the feed assembly, within which the gases are accumulated and intermixed with a portion of water which has been diverted from the main body of water to flow through the feed assembly and then back to the main body of water. This is a division of application Ser. No. 025,291, filed Mar. 30, 1979.

U.S. Pat. No. 4,724,059, issued Feb. 9, 1988, to R. B. Collier, discloses an automated chlorine generator having a power source and an electrolytic cell able to generate chlorine by the electrolysis of sodium chloride. An anode and a cathode are provided each mounted in a separate compartment with chlorine generation in the anode compartment and hydrogen generation in the cathode compartment, the compartments being in communication through an ion permeable membrane. A mixing container having a first compartment to receive hydrogen and chlorine from the cell is provided with an outlet for water in a second compartment, in communication with the first and having an inlet for water and a float valve to control the inlet. Conductivity probes are used for detecting liquid content in the anode and the cathode compartments as well as a flushing system for draining the anode and cathode compartments. A vacuum chamber in the mixing container is used for maintaining chlorine gas under vacuum which is detected by means of other conductivity probes to detect the loss of vacuum in the vacuum chamber. An oxidation reduction potential probe is used at the water inlet for measuring the chlorine concentration in the water.

U.S. Pat. No. 5,362,368, issued Nov. 8, 1994, to Lynn et al., discloses an electrolytic chlorine gas generating system. The system includes an electrolytic cell generating the chlorine gas, a brine tank supplying saturated brine to the anode compartment of the cell, and an acid feed tank containing hydrochloric acid at sufficient concentration to maintain the anolyte brine at less than about pH 4.0. In operation, the brine tank contains solid sodium chloride which dissolves in the brine and replenishes the anolyte brine solution as chloride ion is consumed during electrolysis. The acid feed tank is in fluid communication with the brine tank so that the brine is maintained at a constant volume during electrolysis

U.S. Pat. No. 4,248,715, issued Feb. 3, 1981, to P. D. Olivier, discloses an electrolytic chlorine generator employing a porous ceramic diaphragm for separating strong caustic solutions existing on one side of a cylindrical diaphragm from weak acidic solutions on the other side thereof without deterioration and wherein the anode and cathodes are rings placed concentrically with the diaphragm and in close proximity to it.

U.S. Pat. No. 4,256,552, issued Mar. 17, 1981, to C. T. Sweeney, discloses achlorine generator for use in chlorinating water in swimming pools, baths, reservoirs, sewage, etc. The generator is of the type consisting of two sealed compartments separated by an ion-permeable membrane and having a cathode in one compartment and an anode in the other. Hydrogen is evolved from the cathode compartment and chlorine from the anode compartment. In this generator, an electrically neutral or bipolar electrode (one not connected in the anode-cathode circuit) is positioned between the anode and the cathode adjacent to the ion-permeable membrane in the anode compartment. The chlorine generator is characterized by a more rapid start up in generating chlorine and in more rapid and more efficient generation of chlorine with chlorine being released at both the anode and the neutral electrode.

U.S. Pat. No. 5,037,519, issued Aug. 6, 1991, to B. Wiscombe, discloses an electrolytic chlorine generator for chlorinating a body of water employing a container for housing salt brine and having an anode chamber, an open ended cathode chamber mounted to the anode chamber, and a membrane material which divides the anode chamber from the cathode chamber and means for conducting a part of the flowing water from the main body of water to the cell for chlorination purposes.

The prior art discussed above does not provide a turbine generator system which may be utilized to produce electricity and is preferably adapted for a water purification system with reduced installation, maintenance, and operating costs. Consequently, there remains a need to provide a highly reliable water purification apparatus and method. Those of skill in the art will appreciate the present invention which addresses the above and other problems and long felt needs.

### SUMMARY OF THE INVENTION

Accordingly, it is an objective of the present invention to provide an improved water purification mechanism and method.

Another possible objective of the present invention is to provide an easily installed water purification system.

Yet another possible objective of the present invention is to provide injection of chlorine into turbulent water to magnify the purification effect of the chlorine.

Yet another possible objective of the present invention is to eliminate external energy consumption that is presently being utilized in today's in-line chlorine or ozone generators.

Yet another possible objective of the present invention is easy installation, either in-line, in-line canister, or return jet mounted.

One possible feature of the present invention is a return jet implementation which may connect to a pool wall and utilize the venturi effect of water that is created when water flows through the jet so as to more efficiently and effectively dispense chlorine into the water.

One possible advantage of the present invention is the elimination of external energy consumption that is presently being utilized in today's in-line chlorine or ozone generators. Present day in-line devices require a certified electrician to hook up, wall mounted external power boxes and constant energy consumption.

Another possible advantage of the present invention is the elimination of a flow detection device as required with other electrical chlorine generators, which further reduces the cost to the consumer.

Yet another possible advantage of the present invention is an effective and economical means of chlorine/ozone generation, which is energy efficient and easy to install and enhances the oxidation rate of impurities present in the water.

The above-listed objects, features, and advantages are presented merely as an aid in quickly understanding aspects of the invention and it is to be understood that the above objects, features, and advantages are not intended to limit the invention any manner and do not constitute a complete list of all objects, features, and advantages and may not constitute the objectives, features, and advantages for certain preferred embodiments of the invention.

In one possible embodiment, the present invention may comprise a water purifier for purifying a body of water. The water purifier may comprise one or more elements such as, for example only, a rotatable member mounted within a flow path of the water flowing through piping of a circulation system or filtering system for a body of water, such as a pool or spa. The rotatable member may be mounted for rotation in response to the force of the water flowing through the piping. An electric power source driven by the rotatable member may be utilized to produce electricity in response to the water flowing through the piping. Moreover, in one possible embodiment, an electrically operated water purification unit is connected to the electric power source. The electrically operated water purification unit may be in fluid communication with the water so as to inject its output into the water.

The electrically operated water purification unit may further comprise at least two cell plates configured so that the cell plates are in fluid communication with the water and are operable for producing a chemical/electrical reaction that produces a flow of chlorine for purifying the body of water.

The electrically operated water purification unit may also or alternatively comprise at least one of an ozone generator or a UV generator or a chlorine generator.

In one embodiment, the water purifier may further comprise an external housing mounted adjacent to the flow path of the water defining a cavity therein. If desired, the chlorine generator, or an ozone generator, or a UV generator, or wiring for the electric power source may be mounted within the external housing. A flow pickoff such as a tap or deflector or director may be utilized to direct a portion of the water in the flow path into the cavity.

The turbine may further comprise a rotating magnetic field generator with one or more magnets mounted to the rotatable member and responsive to rotation of the rotatable member for creating a rotating magnetic field.

The water purifier may further comprise a ring of magnetic material mounted for rotation in response to the rotating magnetic field. The rotating ring may be utilized to drive a generator or alternator. The water purifier may also comprise a plurality of conductors in which the electricity is produced in response to the rotating magnetic field whereby the electricity so produced is utilized by the water purification unit. The electricity may be regulated, filtered, rectified, or the like, in any desired manner so as to be compatible with the requirements of the electrically operated water purification unit.

In one embodiment, the electrically operated water purification unit produces an output, the rotatable member produces turbulence in the water flowing through the piping, the output from the water purification unit is directed into the turbulence to thereby enhance the effect.

In another embodiment of the invention, a container may be secured to piping for water which may or may not be related to a pool or spa. Salt may be introduced or stored within the container and water from the piping may be directed into the container to produce a salt brine or salt water within the container. A water purification unit of some type may be mounted within the container which comprises elements reactive with the salt water to produce an output for purifying the water.

In another embodiment, the present invention may comprise a turbine electric power generator for a swimming pool or spa which comprises one or more elements, such as for example, a rotatable member mounted within a flow path of the water through the piping, the rotatable member being mounted for rotation in response to a force of the water flowing through the piping; and an electric power source driven by the rotatable member to produce electricity in response to the water flowing through the piping. The turbine electric power generator may further comprise a connector for connecting to at least one outlet or at least one inlet of a filtering system for a pool or spa. The turbine electric power generator may further comprise a light or other equipment powered by the electric power source.

### BRIEF DESCRIPTION OF DRAWINGS

For a further understanding of the nature and objects of the present invention, reference should be had to the following detailed description, taken in conjunction with the accompanying drawings, in which like elements may be given the same or analogous reference numbers of a water purifier apparatus in accord with the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

FIG. 1 is an elevational view, in section, showing one possible embodiment of the present invention which comprises an in-line chlorine generator with a turbine that utilizes magnetic torque to produce regulated DC voltage for application to in-line cell plates whereby chlorine is generated and forced through the turbine by the flow of water and is thereby subjected to the turbulent effect of oxidation in accord with the present invention.

FIG. 2 is a cross-sectional view of one possible embodiment in accord with the invention of a turbine and magnetic torque drive which may be utilized in the embodiment of the invention shown in FIG. 1.

FIG. 3 is an elevational view, in section, showing another possible embodiment of the present invention wherein as the turbine spins, magnets affixed to the cylinder of the turbine spin rapidly past the fixed copper wound magnets, forcing a current to be generated which in turn is sent to the voltage regulator, and then to in-line cell plates.

FIG. 4 is an elevational view, in section, showing yet another possible embodiment of the present invention wherein cell plates and/or possibly UV and/or Ozone generators are positioned out of the path of the circulated water with a chamber, and utilize a pick-off or other tap means to direct water to the chamber.

FIG. 5 is an elevational view, in section, showing one possible arrangement of components for an embodiment of the present invention comprising a separate chamber for circulated water as might be utilized in or similar to the embodiment of FIG. 4.

FIG. 6 is an elevational view of another embodiment of the present invention which may be attached to the output and used as a jet for a pool circulation system wherein a chamber is provided which receives water from the pool for sanitation and after treatment the water flows out from the jet.

FIG. 7 is an elevational view, in section, which shows one possible internal component arrangement for use in the embodiment of FIG. 6 wherein the flow of water is indicated as it is drawn in through the back and/or through the sides, through the actively charged cell plates, through the portals, and back into the pool.

FIG. 8 is a cross-sectional view showing one possible embodiment of a turbine gear assembly in accord with the present invention.

FIG. 9 is an elevational view showing one possible embodiment of the present invention which includes an adapted light assembly.

FIG. 10 is an elevational side view of one possible embodiment of the present invention which may be attached to a return jet in a pool circulation system in which includes portals for water flow.

FIG. 11 is an elevational view of one possible embodiment of the present invention which may be attached to a return jet for a pool circulation system which shows potential water flow into and out of a treatment housing.

FIG. 12 is an elevational view of one possible embodiment of the present invention which may be attached to her he return jet and includes an adjustment for a paddle wheel assembly.

FIG. 13 is an elevational view of one possible embodiment of the present invention which uses a paddle wheel instead of a turbine.

FIG. 14 is an elevational view, in cross-section, showing another embodiment of the present invention which utilizes a turbine generator and a salt filled canister. In this embodiment, cell plates may be affixed at the top of the canister and water may be directed upwardly through the salt to the actively charged cell plates to separate the chlorine molecules and release the chlorine molecules back into the system through a feed tube, and introduce the chlorine molecules back into the flow tube with a turbulent effect.

FIG. 15 is a diagram of a circulation system for a typical pool or spa which indicates some of the various positions in which embodiments of the present invention may be utilized.

FIG. 16 is a schematic for an electrostatic water cleaner in accord with one possible embodiment of the present invention.

While the present invention will described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### GENERAL DESCRIPTION AND PREFERRED MODES FOR CARRYING OUT THE INVENTION

In one embodiment of the present invention, means are provided to produce chlorine in a body of water by and electrolysis chemical reaction without the need to install electrical wiring. It is often desirable to avoid electrical wiring as much as possible around pools and spas.

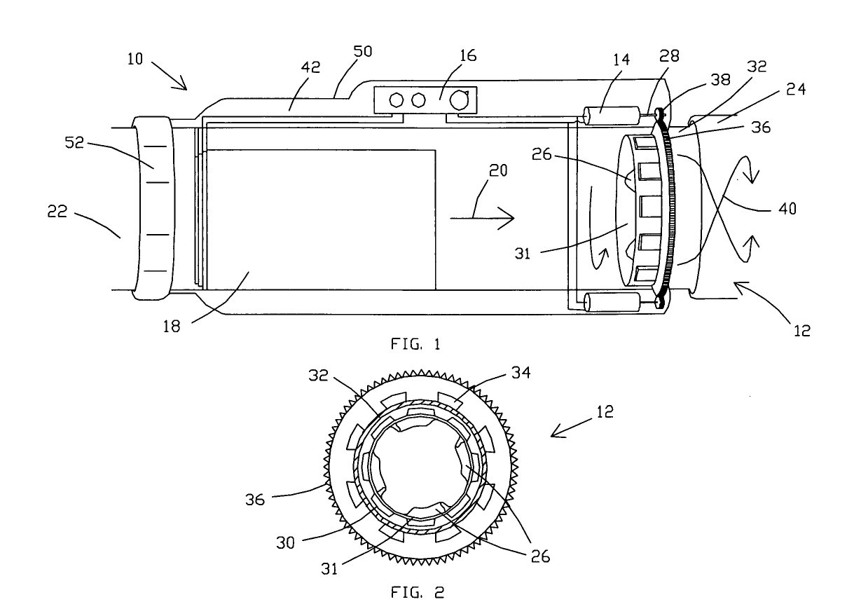

Referring now to the drawings, in more particularly to FIG. 1, there is shown one possible embodiment of a turbine chlorine generator 10 in accord with the present. Connections 52 may be utilized for in line installation of a turbine chlorine generator as described herein.

Turbine chlorine generator 10 comprises a turbine 12. DC voltage generator 14 and voltage regulator 16 produce a DC voltage that is applied to cell plates 18. DC voltage generator 14 and voltage regulator 16 may comprise any suitable power generator such as alternators generators, regulators, or other power supplies that may be used to supply a DC voltage to cell plates 18.

Turbine 12 rotates in response to the flow of fluid, as indicated by arrow 20, through pipe sections 22 and 24. For instance, when turbine 12 is enacted upon by the force of water generated by a circulation pump(s), which is utilized to circulate and filter water in a body of water; the force of the water through the plumbing engages an in-line turbine(s), wheel(s) or impeller(s) thereby causing rotation. And blades, propellers, paddle wheels, screws, plate assemblies, and other suitable water driven elements may be utilized for implementation of turbine 12. The various dimensions of the driven elements such as fin length and pitch may be utilized to control fluid flow, fluid turbulence, power output, turbine speed, and other factors of interest. Other fixed or non-rotating fins, diffusers, venturi's, and the like, may also be utilized to control fluid flow, turbulence, fluid pressure, as desired within turbine chlorine generator 10.

In this example, blades 26 mounted on cylinder 31 rotate in response to fluid flow as indicated by arrow 20. This rotation of the turbine then engages shaft 28 of DC voltage generator(s) 14. Transference of power between turbine 12 and DC voltage generator 14 can be effected by any suitable means. For instance, turbine 12 may engage any electromagnetic configuration or a gear assembly attached to shaft 28 of DC voltage generator 14. In another embodiment, transference of power could be obtained through the use of magnetic torque thus protecting the integrity of the pipe. In the embodiment of FIG. 1 in FIG. 2, rotation held blades 26 results in rotation of magnets 30. Magnets 30 are mounted internally to pipe 32 on cylinder 31. Rotation of the ring of magnets 30 produces a rotating magnetic field which engages outer magnets 34. The rotating magnetic field causes the ring of outer magnets 34 to rotate thereby causing drive gear 36 to rotate. Rotation of drive gear 36 then drives corresponding gear 38 and shaft 28 of DC voltage generator 14 to rotate so as to produce power. The power then generated is transferred to voltage regulator 16 which in turn is transmitted to cell plates 18.

Cell plates 18 may be constructed of any suitable material. In this embodiment, cell plates 18 comprise a ruthenium-coated titanium. As another example, cell plates 18 may comprise coated metals, carbon materials, treated stainless steel, titanium, or other specialized metals. Although cell plates 18 are shown as being substantially rectangular, cell plates 18 may have various shapes. For instance, cell plates 18 may be tubular and may be arranged as concentric tubulars. Cell plates 18 may also be shaped and mounted so as to enhance their effectiveness. For instance, cell plates 18 may be shaped as fins or otherwise shaped or configured so as to create turbulence into which chlorine ions, atoms, or molecules are injected. DC voltage is applied to cell plates 18 which are arranged in an anode and cathode configuration so as to require at least two cell plates 18. One advantage of the present invention is the it is not necessary to provide an expensive fluid flow safety switch to positively turn power off at cell plates 18 when fluid is not flowing through turbine 12 to avoid damage to cell plates 18.

In one preferred embodiment, salt (NaCL) may be added to a body of water which may be a pool, spa, fountain, or the like. The salt water reacts when it passes through energized cell plates 18, thereby releasing the chlorine molecules from the salt solution through electrolysis. The chlorine molecules are released in the body of water for the purpose of neutralizing bacteria and/or pathogenic organisms. The following chemical equation expresses the process of operation:
NaCL+H₂O+Electricity CL₂+NaOH+H₂

In addition to the introduction of the self-sufficient turbine means of electric generation for the purpose of electrolysis in chlorine generation, turbine 12 creates a turbulent enhanced means of introducing chlorine gas to water which greatly intensifies the process or effect of oxidizing the water, thereby producing a more efficient and effective means of disrupting pathogenic organisms or impurities, which in turn would reduce the required run time on the circulation pump to properly sanitize a body of water. In other words, chlorine molecules produced by cell plates 18 are introduced into turbulent water as indicated by arrows 40. Due to the turbulence, chlorine molecules have a greater chance of more quickly and efficiently engaging pathogens for purification than if the chlorine molecules were introduced into placid water. In other words, the chlorine gas is forced through the turbine by the flow of water and is subjected to the turbulent effect of oxidation.

Reverse DC voltage on cell plates can be used to remove calcium buildup or other deposits. If desired, reversing switch 42 may be utilized to reverse DC voltage applied to cell plates 18. Reversing switch 42 may be implemented in various ways. For instance, reversing switch 42 may be a manual switch or an automatic switch. If manual, a switch may be provided on housing 50 to permit operation as desired. If automatic, the reversing switch 42 may comprise a timer which could be electronic, mechanical, or electromechanical. For instance, a gear driven mechanical switch driven by in gear 36 may be designed to provide a selected number hours of operation and then a selected amount of time during which reverse DC voltage is applied to cell plates 18. As another example, reversing switch 42 may comprise an electromechanical clock motor driven by the same DC voltage which is applied to cell plates 18. As another example, the reversing switch 42 may comprise a battery-operated switch or chargeable battery-operated switch. As another example, reversing switch 42 may comprise a multiplexer which applies a desired regulated voltage of desired polarity on all or selected individual cell plates 18 as may be programmed into reversing switch 42. As another example, reversing switch 42 may comprise a wave generator which produces a variable DC voltage.

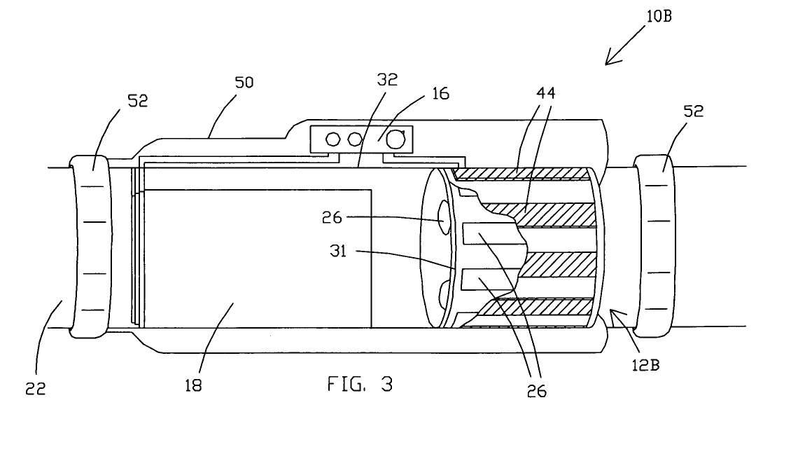

FIG. 3 discloses another embodiment of the present invention with turbine chlorine generator 10B and turbine 12B, wherein the external generator and gearing discussed above are not necessary. For instance, internally positioned rotating permanent magnets 30, located inside plastic or PVC pipe 32, may be rotated by fluid driven turbine blades 26 to create a rotating magnetic field which cuts stator wires of symbolically illustrated externally positioned stator elements 44, which may be located outside plastic or PVC pipe 32. The alternating current so produced in stator elements 44 may be rectified and regulated utilizing voltage regulator 16. As another example, when the turbine spins, rotating permanent magnets 30 affixed to cylinder 31 of the turbine spin rapidly past the fixed copper wound magnets symbolically illustrated this stator elements 44, forcing a current to be generated which in turn is sent to voltage regulator 16, then to the cell plates 18. As another example, the entire generator or alternator may be mounted entirely within pipe 32 utilizing fluid tight wiring connections which extend through pipe 32. As another example, all power generation and voltage generation and wiring may be mounted inside pipe 32 along with cell plates 18 so that no external wiring is utilized. As another example, if alternating current is produced, regulator 16 may be mounted internal to pipe 32, and a coil may be utilized to transfer the alternating current new regulator 16 without the need for wiring through pipe 32.

Various types of generators and alternators may be utilized to produce power for cell plates 18. Such generators and alternators may include permanent magnets, electromagnets, feedback controlled electromagnets, as desired, with appropriate wiring extending through pipe 32 as necessary.

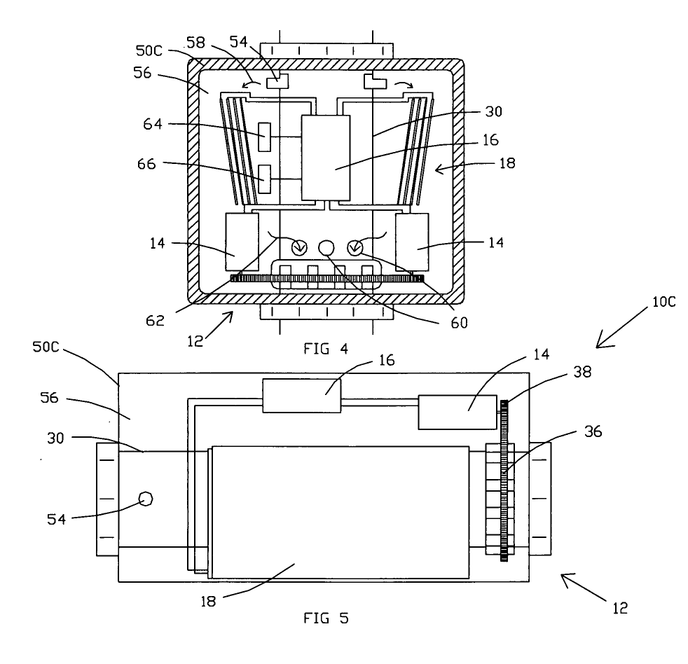

FIG. 4 and FIG. 5 illustrate another configuration for in-line turbine chlorine generator 10C in accord with the present invention. Turbine chlorine generator 10C has cell plates 18 positioned outside of the path of the circulated water in pipe 30. In this example, cell plates 18 are contained within housing 50C. In this embodiment, pick-off 54 or tap means may be utilized to direct water to the cell chamber 56 as indicated by fluid flow arrows 58. In this embodiment, a smaller amount of amperage is needed to actively separate the chlorine from the salt solution. Thinner cell plates 18 can be utilized because cell plates 18 are not affected by the force of the water. The chlorine generated by cell plates 18 is then pulled back into the fluid flow through pipe 30 by portals 60 as indicated by arrows 62 utilizing a vacuum or venturi effect due to the faster flow of fluid through pipe 30.

In another embodiment, electric power from turbine 12 can be utilized to power ozone (03) generator(s) or ozonator(s) as indicated at 64. If desired, power can also be applied to UV light generator 66 to enhance the performance of ozone generators 64. The turbulent effect that is created enhances the purification effect of ozone. Ozone has a very low residual time of less than two seconds and relies solely on the ozone bubbles randomly contacting the impurities to be effective. Thus, by feeding the ozone created by ozone generator 64 into turbulent water, the purification effect of the ozone is significantly enhanced. The chlorine and the ozone that are generated are both gases and if not fed into portals 60 into turbulent fluid in accord with the present invention would tend to rise to the top of the pipe.

While the embodiment shown in FIG. 4 utilizes cell plates 18, ozone generator 64, and UV light generator 66 mounted in the same housing 50C, utilization of all these components simultaneously is not required. For instance, ozone generator 64 and UV light generator 66 may be mounted in a separate housing with a separate turbine to generate power. In that case, ozone generator 64 and UV light generator 66 may be utilized with or without turbine chlorine generator 10. For that matter, ozone generator 64 and/or UV light generator 66 may be utilized in a separate housing. It will be understood that any combination of a chlorine generator, ozone generator, UV light generator, or any other desired power operated device may be utilized for operation with one or more turbine generators, some examples of which have been shown herein. Moreover, the relative positions of the various generators within housing 50C can vary. For instance, ozone generator 64, UV light generator 66 may be on opposite sides of housing 50C. As well, other configurations and positioning of one or more of ozone generators 64, UV light generator 66, and cell plates 18 may be used as desired. Regulator 16 or other suitable power controls may be utilized to operate ozone generator 64 and/or UV light generator 66.

Fluid taps 54 may be selected in size, shape, and orientation, to produce a desired amount of fluid flow through interior 56 of housing 50C. As well, venturi components or turbulence control elements, some of which were discussed above, may also be utilized to control the fluid flow through interior 56.

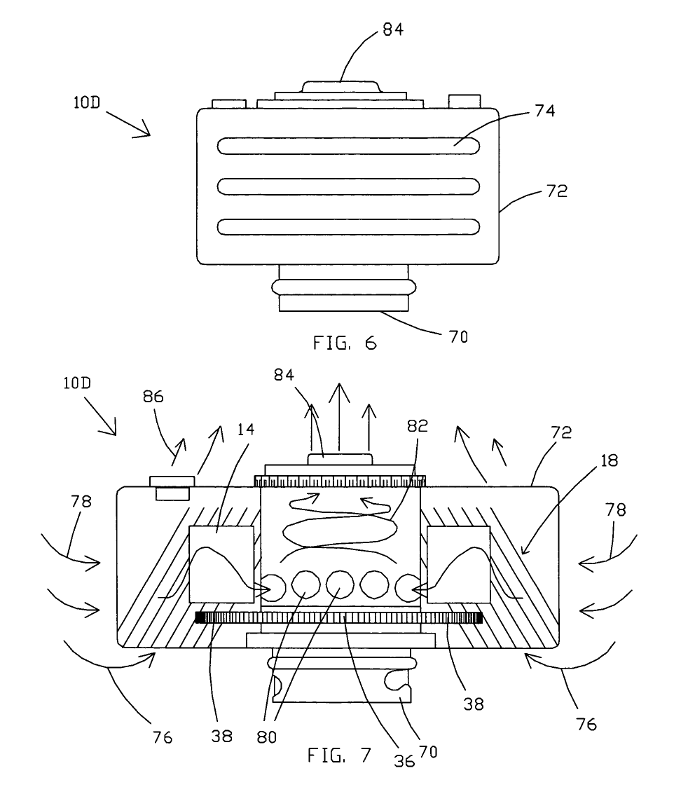

FIGS. 6, 7, and 8 illustrate another embodiment of the present invention wherein turbine chlorine generator 10D may be connected to a return jet in a pool our spa or the like by means of a quick connector or adaptor. The return jet may normally have fluid flow therethrough due to operation of the filtering system which circulates water in the pool or spa. In this embodiment, connector or adapter 70 may be shaped as desired for connecting to the return jet. Connector or adapter 70 may be a various types and maybe snap on, screw on, or glued as necessary.

In this embodiment, if desired, fluid or water may be taken into housing 72 directly from the pool or body of water rather than from the pipe or return jet. Thus, fluid may be drawn into housing 72 via vents 74 positioned on the side, rear, and possibly even the front of turbine chlorine generator 10D as generally indicated by fluid flow arrows 76 and 78. The fluid is drawn through cell plates 18 were chlorine molecules are generated and back into portals 80 where the fluid flow is turbulent as indicated by arrows 82. Water then exits housing 72 via jet or outlet 84. If desired, water could also be directed out the front of housing 72 as indicated by flow arrows 86.

This embodiment of the present invention permits installation of the chlorine generator without the need for cutting a pipe and inserting the generator within the cut out section. If a suitable connector is provided, the installation or removal of the chlorine generator may take only a few seconds. Thus, this embodiment permits installation of a turbine chlorine generator within seconds.

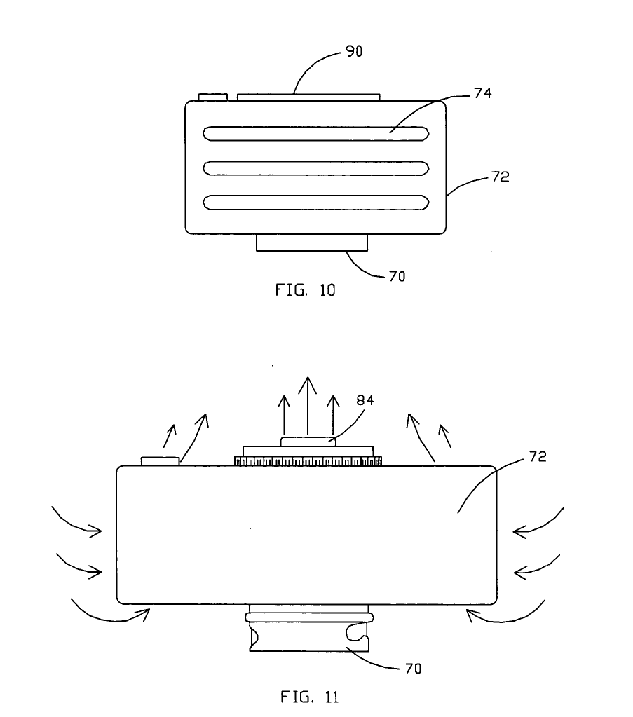

The embodiment of FIG. 9, 10, and 11 show another possible use for the turbine generator of the present invention for connection to the outlet jet wherein a chlorine generator or other type of purification generator may not be utilized at all. For instance, in this embodiment power from the turbine generator may be utilized to power pool light 90. Thus, this embodiment permits installation of a pool light within a short time and possibly within seconds, depending on adapter or connector 70 as discussed above. This embodiment may also be utilized with a chlorine generator and therefore may utilize vents 74 as discussed above. Switch or knob 94 may be utilized to control the intensity of pool light 90. If desired, a battery may also be included with a battery charger for operation of the pool light and/or other electrically operated devices without fluid flow through the outlet jet. Power may also be generated and supplied to an outlet 92 which may be utilized to power a robotic pool cleaner or the like without the need to run a power cord to the pool. It will be understood that a low voltage may preferably be utilized for safety purposes.

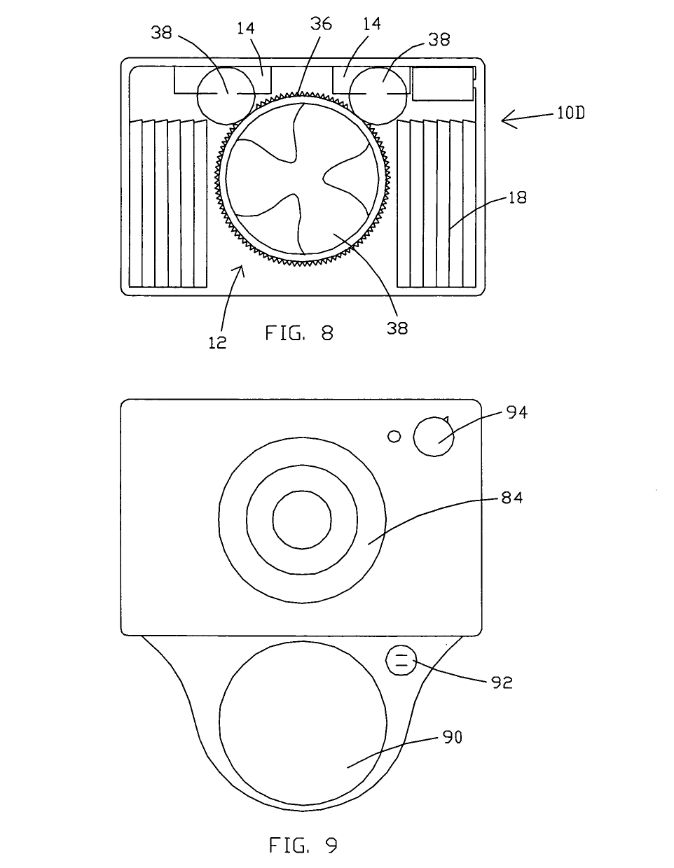

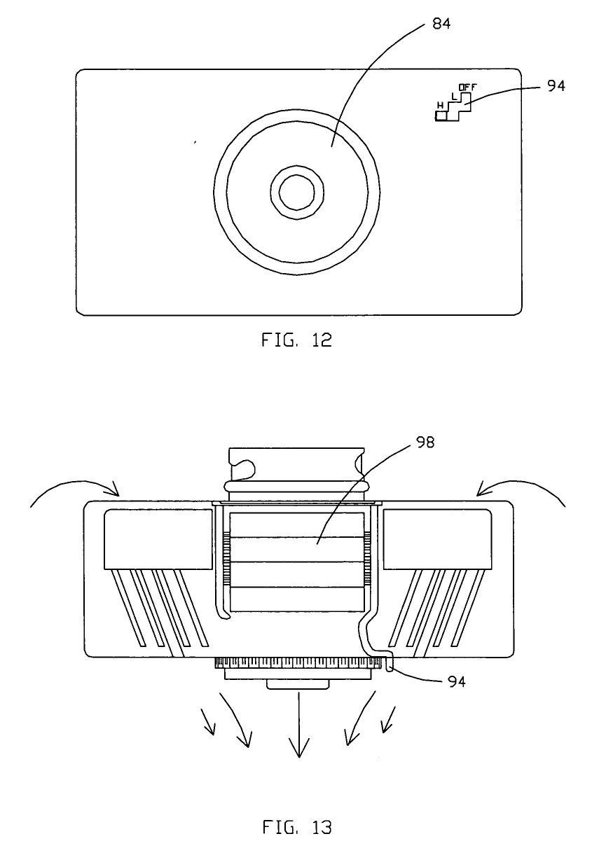

The embodiments of FIG. 12 and FIG. 13 utilize a paddlewheel assembly 98. In this embodiment, switch or lever 94 may be utilized to control the operation or output of paddlewheel assembly 98. It will be noted that FIG. 8 shows and embodiment of the invention which utilizes propeller 100 within turbine 12.

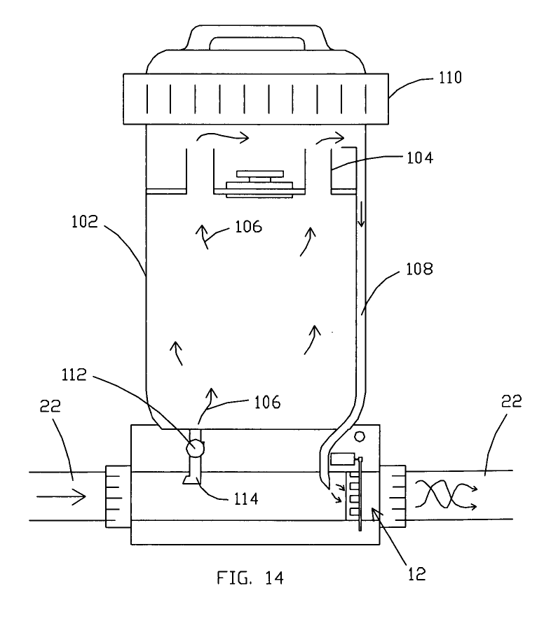

FIG. 14 illustrates another embodiment of the present invention. In this embodiment, turbine generator 12 is utilized in conjunction with salt filled canister 102. Cell plates 104 may be affixed at the top of canister 102. Water may be directed upwardly through salt filled canister 102 as indicated by arrows 106 to actively charged cell plates 104. Cell plates 104 separate the chlorine molecules and release them back into the system through the feed tube 108. Feed tube 108 leads back into the turbulent fluid of turbine generator 12 so that the chlorine molecules are then introduced via the turbulent effect as discussed above. In this embodiment, top 110 may be utilized to fill canister 102 with salt and/or service cell plates 104. Knob 112 may be utilized to control the fluid flow through inlet 114. This embodiment of the invention may have various uses including uses for sanitizing pool water, spa water, or other water which may flow through pipe 22. The salt permits operation of this system regardless of whether salt is present within the fluid which flows through pipe 22. The salt in canister 102 provides saltwater to prevent buildup on cell plates 104 as discussed in my previous patent. However it will be understood that if salt is already present within water or fluid flowing through canister 102 then additional salt may not need to be added to canister 102 in order to produce chlorine. Thus, the present invention may be utilized in a piping system to maintain or prevent algae formation wherein the piping system may not be part of a pool or spa circulation system.

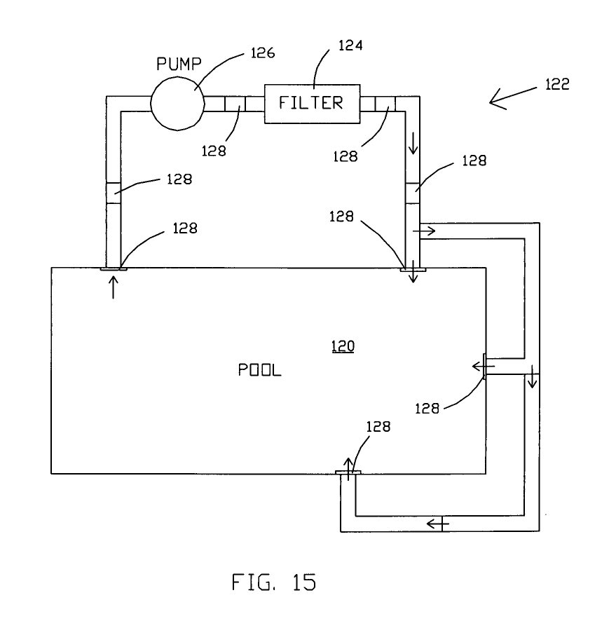

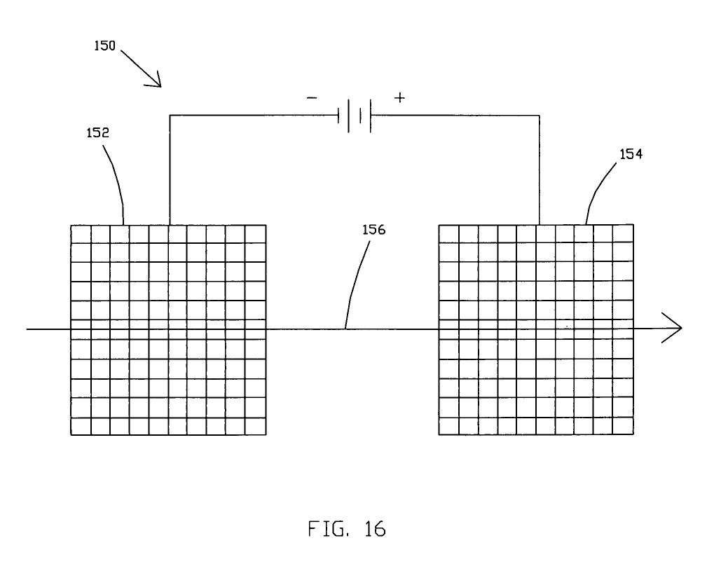

FIG. 15 shows a diagram of a circulation system for a typical spa or pool. Water in pool 120 is filtered utilizing circulation system 122 which circulates water through filter 124 utilizing pump 126. A chlorine generator or UV generator or ozone generator or any combination of the above in accord with the present invention may be mounted at any position in circulation system 122. For instance, chlorine generator 128 or other type of generator may be mounted at any of the positions as designated as 128 as shown in the diagram. Multiple generators 128 or other types of generators may be utilized or only one generator may be utilized. A convenient position for a generator might be adjacent the output of filter 124 because the pipe, such as PVC pipe, is often easily accessible at this point in a typical pool or spa circulation system. A section of the pipe may be cut out and replaced by a chlorine generator or other type of generator as described hereinbefore. As also discussed hereinbefore, a chlorine generator are the type of generator may be mounted to the inlet or outlets of the circulation system.

FIG. 16 discloses electrostatic cleaner 150 which may be utilized to pull charged particles out of water stream 156. In one embodiment, electrostatic cleaner 150 may be utilized in-line with water flow 156 and upstream from the charged plates of a chlorine generator or other charged elements to prevent buildup of charged particles on the charged plates. In many cases, contaminants are charged thereby being attracted to either the positive screen 154 or negative screen 152. Power may be provided by the generator disclosed herein, by batteries, solar cells or the like. As well, screens 152 and/or 154 may be comprised of electronegative or electropositive materials without the need for a power source. Electrostatic cleaner 150 may be positioned as desired although in one preferred embodiment, electrostatic cleaner 150 is positioned in a desired position within pool piping such as PVC piping as illustrated in FIG. 15. While two oppositely charged screens are shown here, electrostatic cleaner may utilize only one cleaning screen, multiple cleaning screens, multiple screens of different charge or the like which are in contact with the water flow. Moreover the screens may comprise various configurations including tubular, multiple tubular with tubular within tubular configuration, fins, propellers, and the like. Electrostatic cleaner 150 does not have to be built in-line with piping. For instance, the electrostatic cleaner 150 may be built into the skimmer bucket, and may comprise partially or wholly the skimmer basket, or may be built into, onto, and/or comprise other pool components, for example only, baskets, brushes, automatic pool cleaners, and the like. Electrostatic cleaner 150 may be mounted on a float for the pool to move around gradually picking up charged elements, e.g., which may form a cloud within the pool. Alternatively, electrostatic cleaner 150 may be mounted in the pool or used in the pool in other ways as desired. Furthermore, electrostatic cleaner 150 may have uses outside the pool in industrial applications, municipal water cleaning applications, and the like, as desired.

Therefore, because many varying and different embodiments may be made within the scope of the inventive concept(s) herein taught. For instance, the present invention may utilize various types of water purification units such as those discussed above and others, e.g. ion generation systems which produce ions that act to purify water. Moreover, the electricity generated may be utilized for any desired purposes, e.g, water treatment including filtering and filters, recreational devices, cleaning tools and devices, or any other purposes. Because many modifications may be made in the embodiment herein detailed in accordance with the descriptive requirements of the law, it is to be understood that the details herein are to be interpreted as illustrative of a presently preferred embodiment and not in a limiting sense.

What is claimed is:

1. A water purifier for purifying a body of water, a circulating system for pumping the water, said circulating system comprising a pump, said circulating system comprising piping which fluidly connects said pump with the body of water, said water purifier comprising:
a rotatable member mounted within a flow path of said water through said piping, said rotatable member being mounted for rotation in response to a force of said water flowing through said piping;
an electric power source driven by said rotatable member to produce electricity in response to said water flowing through said piping;
an electrically operated water purification unit connected to said electric power source, said electrically operated water purification unit being in fluid communication with said water.

2. The water purifier of claim 1, wherein said electrically operated water purification unit further comprises at least two cell plates, said at least two cell plates being in fluid communication with said water and being operable for producing a reaction that produces a flow of chlorine for purifying said body of water.

3. The water purifier of claim 1, wherein said electrically operated water purification unit further comprises at least one of an ozone generator or a UV generator or a chlorine generator.

4. The water purifier of claim 1, further comprising an external housing mounted adjacent to said flow path of said water, said external can housing defining a cavity therein, at least one of a chlorine generator, or an ozone generator, or a UV generator, or wiring for said electric power source being mounted within said external housing.

5. The water purifier of claim 4, further comprising a flow pickoff which directs a portion of said water in said flow path into said cavity.

6. The water purifier of claim 1, further comprising a rotating magnetic field generator, said rotating magnetic field generator comprising a plurality of magnets mounted to said rotatable member responsive to rotation of said rotatable member for creating a rotating magnetic field.

7. The water purifier of claim 6, further comprising a ring of magnetic material, said ring of magnetic material being mounted for rotation and rotatable in response to said rotating magnetic field.

8. The water purifier of claim 7, further comprising a plurality of conductors in which said electricity is produced in response to said rotating magnetic field.

9. The water purifier of claim 1, wherein said electrically operated water purification unit produces an output, said rotatable member producing turbulence in said water flowing through said piping, said electrically operated water purification unit being configured such that said output is directed into said turbulence.

10. A water purifier, a pump for pumping said water, a system of piping for carrying said pumped water, said water purifier comprising:
a container secured to said piping, said container being in fluid communication with said water;
salt within said container to produce a salt brine comprising salt water within said container; and
a water purification unit mounted with and said container, said water purification unit comprising elements reactive with said salt water to produce an output for purifying said water.

11. The water purifier of claim 10, further comprising a rotatable member mounted within a flow path of said water through said piping, said rotatable member being mounted for rotation in response to a force of said water flowing through said piping, an electric power source driven by said rotatable member to produce electricity in response to said water flowing through said piping, said water purification unit being electrically operated and connected to said electric power source.

12. The water purifier of claim 11, wherein said electrically operated water purification unit further comprises a plurality of cell plates.

13. A turbine electric power generator for a swimming pool or spa, a circulating system for circulating water to and from said swimming pool or spa, said circulating system comprising piping with at least one inlet and at least one outlet in fluid communication with said swimming pool or spa, said circulating system comprising a pump to create a water flow through said piping, said turbine electric power generator further comprising:
a rotatable member mounted within a flow path of said water through said piping, said rotatable member being mounted for rotation in response to a force of said water flowing through said piping; and
an electric power source driven by said rotatable member to produce electricity in response to said water flowing through said piping.

14. The turbine electric power generator of claim 13, further comprising an electrically operated water purification unit, said electrically operated water purification unit being responsive to said electricity for purifying said water.

15. The turbine electric power generator of claim 13, further comprising a connector for connecting to said at least one outlet or said at least one inlet.

16. The turbine electric power generator of claim 15, further comprising a light powered by said electric power source.

17. The turbine electric power generator of claim 13, further comprising at least one of a chlorine generator, a UV generator, or an ozone generator, said at least one of said chlorine generator, said UV generator, or said ozone generator being connected to and responsive to said electricity for purifying said water.

18. The water purifier of claim 13, further comprising a rotating magnetic field generator, said rotating magnetic field generator comprising a plurality of magnets mounted to said rotatable member responsive to rotation of said rotatable member for creating a rotating magnetic field.

19. The water purifier of claim 18, further comprising a ring of magnetic material, said ring of magnetic material being mounted for rotation and rotatable in response to said rotating magnetic field.

20. The water purifier of claim 18, further comprising a plurality of conductors in which said electricity is produced in response to said rotating magnetic field.

21. An underwater electrostatic pool filter for filtering charged particles from water within a pool system, comprising:
one or more charged screens mounted within said pool system such that said one or more charged screens contact water whereby said one or more charged screens attract said charged particles to remove them from said water.

22. The underwater electrostatic pool filter of claim 21 wherein said one or more charged screens are comprised of at lease one of electronegative materials or electropositive materials.
